(19) United States
(12) Patent Application Publication
(10) Pub. No.: US 2007/0122086 A1
(43) Pub. Date: May 31, 2007

(54) Optical fiber signal converter

(75) Inventor: Chung-Kuang Lin, Hsintien City (TW)

Correspondence Address: BIRCH STEWART KOLASCH & BIRCH, PO BOX 747, FALLS CHURCH, VA, 22040-0747, US

(73) Assignee: Axcen Photonics Corp.

(21) Appl. No.: 11/396,634

(22) Filed: Apr. 4, 2006

(30) Foreign Application Priority Data
Nov. 30, 2005 (TW) 94142152

(51) Int. Cl. G02B 6/36

(52) U.S. Cl. 385/88

(57) ABSTRACT

The present invention provides a fiber optic signal converter that includes a fiber optic transceiver for transforming the optical signal transmitted in an optical fiber to an electrical signal transmitted to a computer, a PHY IC for transforming the signal to an MII signal or a GMII signal, MAC/USB controller for transforming the signal to a USB signal and a USB port for transmitting or receiving a USB signal.

### RELATED APPLICATIONS

The present application is based on, and claims priority from, Taiwan Application Serial Number 94142152, filed Nov. 30, 2005, the disclosure of which is hereby incorporated by reference herein in its entirety.

### FIELD OF THE INVENTION

The present invention is related to a converter, and more particularly to an optical fiber signal converter.

### BACKGROUND OF THE INVENTION

The signal volume transmitted in an optical fiber line is equal to the signal volume transmitted in thousands of typical copper lines. Therefore, optical fibers have replaced copper lines to become the main signal transmission carrier today. Moreover, an optical signal is immune to noise and may provide broad bandwidth to carry a mass signal volume. Therefore, with the technological development of fiber optics, optical communication plays an important role in communication today.

An Ethernet is a typical main local area network. To connect to an Ethernet, an Ethernet card and a connector are installed in a computer. The 100Base-T is a typical Ethernet connection type. In this connection type, the twisted pair wire is used to connect the computer to the Ethernet. A RJ-45 connector is installed in the computer to connect with the twisted pair wire. Therefore, when an optical fiber replaces the twisted pair wire to connect with the computer, a converter is required to transform the optical signal to a signal accepted by the RJ-45 connector.

In other words, when a computer wants to connect to a typical fiber optic network, the computer has to have a RJ-45 connector and an additional power supply to supply power to the converter. However, today, RJ-45 connectors are not common in computer systems. Moreover, the highest transmission velocity of the 100Base-T connector is 100 Mbps, which limits the development of the fiber optic network.

Therefore, an improved system is desired.

### SUMMARY OF THE INVENTION

The main purpose of the present invention is to provide a fiber optic signal converter that can transform a fiber optic signal to a USB signal.

According to the foregoing purposes, the present invention provides a fiber optic signal converter that includes a fiber optic transceiver, a physical layer integrated circuit (PHY IC), a media access control/universal serial bus controller (MAC/USB controller), a USB port and a power circuit. The fiber optic transceiver is used to transform the optical signal transmitted in the optical fiber to an electrical signal that transmits to computers. The PHY IC is used to transform the signal that is received from or transmitted to the fiber optic transceiver to a Media Independent Interface signal (MII signal) or a Gigabit Media Independent Interface (GMII signal). The signal, MII signal or GMII signal, is sent to the MAC/USB controller. The MAC/USB controller is used to transform the signal that is transmitted from or transmitted to the PHY IC to a USB signal. The USB port may transmit or receive a USB signal.

In another embodiment, a wireless module may be installed in the USB port to perform wireless communication.

In another embodiment, a microprocessor is installed in the fiber optic signal converter to monitor the usage status of the fiber optic transceiver. The monitored result is sent to a display interface to display the result.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIG. 1 is a schematic diagram of a fiber optic converter of the present invention.

FIG. 2 is a schematic diagram of a fiber optic converter with a microprocessor.

FIG. 3 is a schematic diagram of a fiber optic converter with a wireless module.

FIG. 4 is a schematic diagram of a fiber optic converter with a microprocessor and a wireless module.

FIG. 5 is a schematic diagram of a fiber optic converter without a fiber optic transceiver.

### DETAILED DESCRIPTION OF THE PREFERRED EMBODIMENT

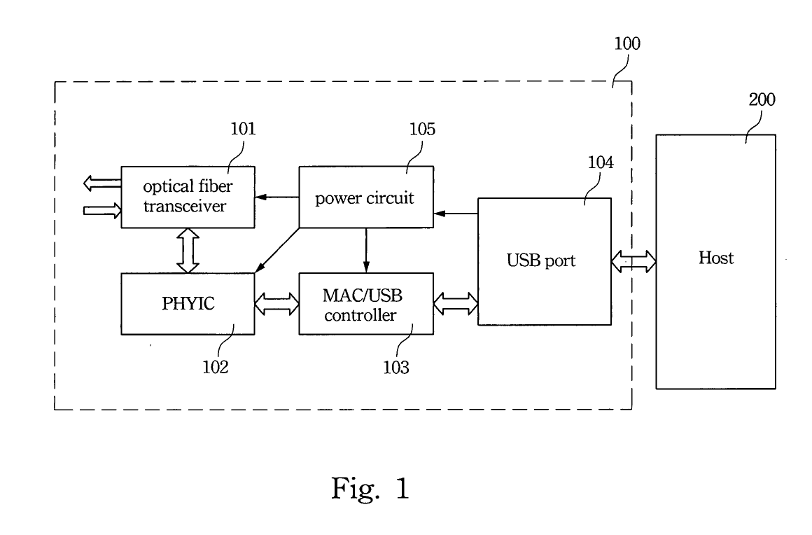

FIG. 1 is a schematic diagram of a fiber optic converter of the present invention. The fiber optic signal converter 100 includes a fiber optic transceiver 101, a PHY IC 102, a MAC/USB controller 103, a USB port 104 and a power circuit 105.

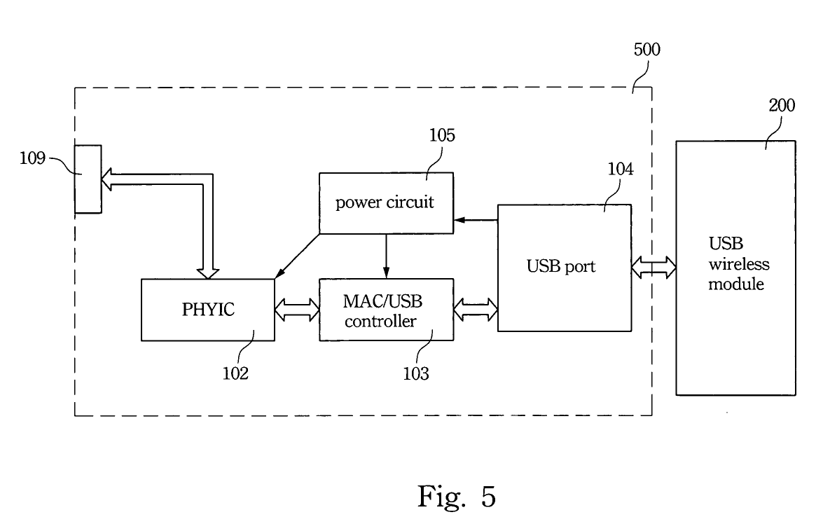

In another embodiment the fiber optic transceiver 101 is pluggable. In this embodiment, the fiber optic signal converter 500 does not include the fiber optic transceiver 101 as shown in FIG. 5. An additional interface 109 is installed in the fiber optic signal converter 500 for connecting with a pluggable fiber optic transceiver. For the purpose of a detailed description, the following embodiment includes the fiber optic transceiver 101.

Please refer to FIG. 1 again. The fiber optic transceiver 101 is used to transform the optical signal transmitted in the optical fiber to an electrical signal that transmits to computers, or transforms electrical signals from the computers to an optical signal transmitted in the optical fiber. The light source of the fiber optic transceiver 101 is a laser diode or a laser emitting diode.

The PHY IC 102 coupled with the fiber optic transceiver 101 defines the requirement information for transmitting and receiving digital data, such as the electrical signal information, the optical signal information, the clock cycle information, the transmission parameters information and so on. The PHY IC 102 is used to transform the signal that is from or transmitted to the fiber optic transceiver 101 to a MII signal or a GMII signal. It is noticed that the other signals, such as the RGMII signal, SGMII signal, TBI signal, RTBI signal or other signals that can communicate with the MAC, all can be used in the present invention. In an embodiment, the PHY IC 102 is selected from the following PHY ICs: Marvell 88E1111 PHY IC manufactured by the Marvell company, VSC8211 PHY IC manufactured by the Vitesse company and BCM5461S PHY IC manufactured by the BroadCom company.

The MAC/USB controller 103 is connected to the PHY IC 102. The MAC controller is responsible for transmitting or receiving the MII or the GMII signal and transforms them to USB signals. In other words, the MII or GMII is used as an interface between the MAC/USB controller 103 and the PHY IC 102. The transformed USB signals are sent out form from the USB port 104.

A host 200 with a USB port may communicate with the USB port 104 to receive the fiber optic signal. Moreover, the USB port 104 may transmit power too. Therefore, a power circuit 105 is installed in the fiber optic signal converter 100 to receive the power transmitted from the USB port 104. The power circuit 104 may allocate the received power to the fiber optic transceiver 101, the PHY IC 102 and the MAC/USB controller 103.

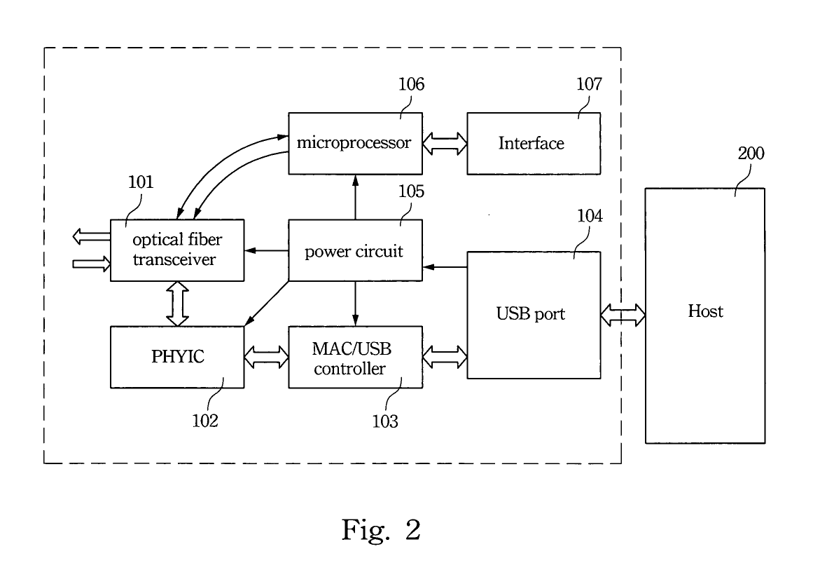

On the other hand, in another embodiment, for preventing a waste of bandwidth caused by abnormal usage of the fiber optic transceiver 101, a microprocessor 106 is selectively installed in a fiber optic converter 100, as shown in the FIG. 2, to monitor the usage of the fiber optic transceiver 101. In this embodiment, the monitored result may be transmitted to an interface 107, such as a USB interface or a RS232 interface, to display on a monitor.

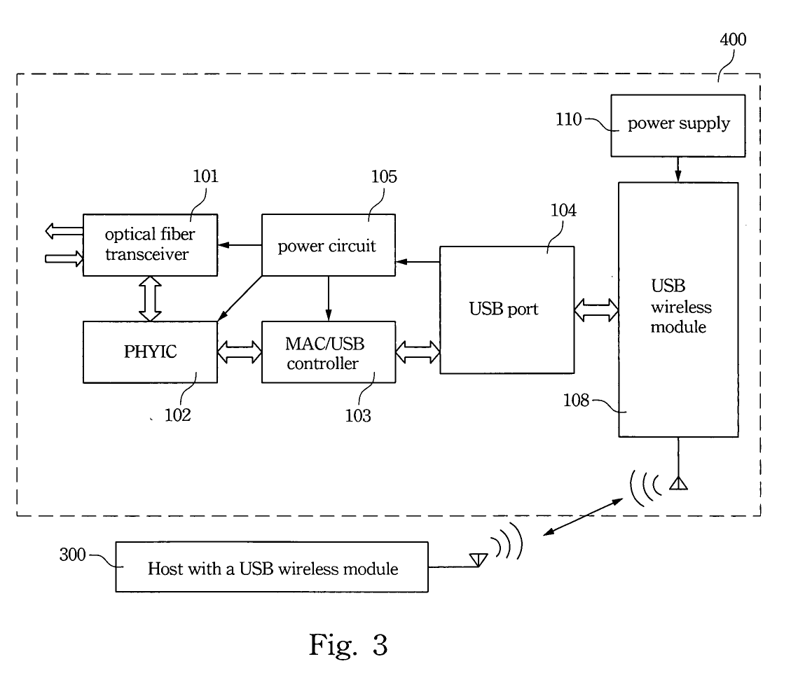

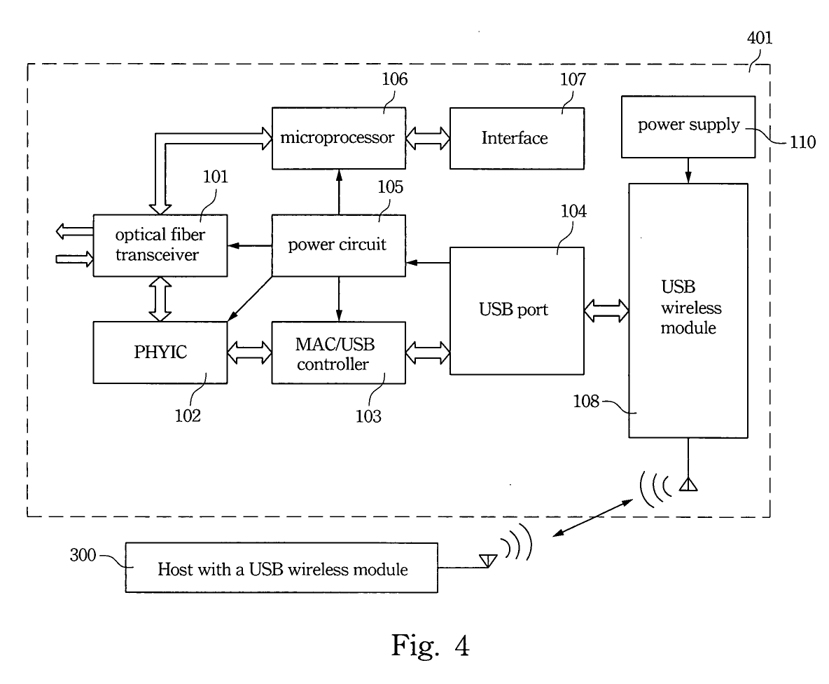

On the other hand, as shown in the FIG. 3, a USB wireless module 108 is installed in a fiber optic converter 400 to couple with the USB port 104 to perform wireless communication with a host 300 with a wireless USB module. In this embodiment, an isolated power supply 110 is required to supply power to the fiber optic converter 400. Similarly, to prevent a waste of bandwidth caused by abnormal usage of the fiber optic transceiver 101, a microprocessor 106 is selectively installed on a fiber optic converter 401, as shown in the FIG. 4, to monitor the usage of the fiber optic transceiver 101. In this embodiment, the monitored result may be transmitted to an interface, such as a USB interface or a RS232 interface, to be displayed on a monitor.

Accordingly, the fiber optic signal converter may transform an optical signal transmitted in the optical fiber to a USB signal. Due to power being transmitted through a USB port, such a converter may not only improve the transmission velocity, but also remove an additional power supply to reduce the production cost and to simplify the wire connections. Moreover, the fiber optic signal converter may perform wireless communication by installing a wireless module.

When the fiber optic signal converter is installed in a computer, a new network interface is built. Therefore, the fiber optic signal converter does not occupy the original network interface. On the other hand, the fiber optic signal is removable from the computer. Moreover, a USB port may support a hot pluggable function and is commonly used in a computer. Therefore, the USB port is very suitable for use in FTTH and FTTD applications. The typical RJ-45 converter may not have the foregoing advantages.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A fiber optic signal converter, comprising:
a physical layer circuit for transforming an electrical signal to a Media Independent Interface signal; and
a controller coupled with said physical layer circuit for transforming said Media Independent Interface signal to a USB signal.

2. The fiber optic signal converter of claim 1, further comprises a transceiver for transforming an optical signal to an electrical signal or transforming an electrical signal to an optical signal.

3. The fiber optic signal converter of claim 2, wherein said transceiver is connected with an optical fiber.

4. The fiber optic signal converter of claim 2, further comprises a monitor coupling with said transceiver to monitor said transceiver.

5. The fiber optic signal converter of claim 4, further comprises a display to show the result after monitoring.

6. The fiber optic signal converter of claim 1, wherein said Media Independent Interface signal is a Gigabit Media Independent Interface signal.

7. The fiber optic signal converter of claim 1, further comprises a USB port for receiving or transmitting said USB signal.

8. The fiber optic signal converter of claim 7, further comprises a power circuit coupled with said USB port, wherein power is transmitted to said power circuit through said USB port and said power circuit allocates said power to said physical layer circuit and said controller.

9. The fiber optic signal converter of claim 7, further comprises a wireless module coupled with said USB port to transmit or receive said wireless USB signals.

10. The fiber optic signal converter of claim 9, further comprises a power supply to supply power to said wireless module.

11. The fiber optic signal converter of claim 10, further comprises a power circuit coupled with said USB port, wherein said power supply supplies power to said power circuit through said USB port and said power circuit allocates said power to said physical layer circuit and said controller

12. A fiber optic signal converter, comprises:
a transceiver for transforming an optical signal to an electrical signal or transforms an electrical signal to an optical signal
a physical layer circuit coupled with said transceiver for transforming an electrical signal to a Media Independent Interface signal; and
a controller coupling with said physical layer circuit for transforming said Media Independent Interface signal to a USB signal;
a USB port for transmitting said USB signal; and
a power circuit for coupling with a power supply through said USB port, wherein said power supply supplies power to said power circuit through said USB port and said power circuit allocates said power to said transceiver, said physical layer circuit and said controller.

13. The fiber optic signal converter of claim 12, wherein said transceiver is connected with an optical fiber.

14. The fiber optic signal converter of claim 12, wherein said Media Independent Interface signal is a Gigabit Media Independent Interface signal.

15. The fiber optic signal converter of claim 12, further comprising a wireless module coupled with said USB port to transmit or receive said wireless USB signals.

16. The fiber optic signal converter of claim 15, wherein said wireless module is powered by said power supply.

17. The fiber optic signal converter of claim 12, further comprises a monitor coupled with said transceiver to monitor-said transceiver.

18. The fiber optic signal converter of claim 17, further comprises a display to show the result after monitoring.
